(19) United States
(12) Patent Application Publication
(10) Pub. No.: US 2016/0256992 A1
(43) Pub. Date: Sep. 8, 2016

(54) MULTI-USE IMPACT TOOL

(71) Applicant: Ian MACPHEE, Calgary (CA)

(72) Inventor: Ian Macphee, Calgary (CA)

(21) Appl. No.: 14/392,402

(22) PCT Filed: Nov. 18, 2014
(86) PCT No.: PCT/CA2014/000817

§ 371 Date: May 11, 2016

Related U.S. Application Data
(60) Provisional application No. 61/962,852, filed on Nov. 18, 2013.

(51) Int. Cl. B25D 1/16; B25F 1/00

(52) U.S. Cl. CPC B25D 1/16; B25F 1/006

(57) ABSTRACT

A multi-purpose impact tool includes an elongated guide bar including cylindrical top and bottom ends and an intermediate section having a polygonal cross section; an annular guide disc on a cylindrical top end of the bar, a head for mounting on the bottom end of the bar for delivering an impact force from the tool; a cylindrical sleeve for sliding on the guide disc for impacting the head; a plug in the bottom end of the sleeve with a polygonal hole for receiving the intermediate section of the bar and preventing rotation of the sleeve on the bar; and a lock on the upper end of the sleeve for locking the guide bar in the sleeve when the tool is not in use.

### FIELD OF THE INVENTION

This invention relates to a manually operated, multi-purpose impact tool.

More specifically, the invention relates to a tool designed for manual operation which can be used to perform many diverse functions including, inter alia, wood or brick splitting, ice scraping, soil tamping or trenching, survey pin driving and the forming of pilot holes for survey markers or other stakes.

### BACKGROUND OF THE INVENTION

Including the Lamoureux and MacPhee U.S. Pat. No. 6,109,365, issued Aug. 29, 2000, there are many patents relating to impact devices of the type described herein including Canadian Patent No. 1,200,182, issued to L. Beaulieu et al on Feb. 4, 1986, and U.S. Pat. No. 4,280,540, issued to G. B. Kirby Meacham on Jul. 28, 1981; U.S. Pat. No. 4,308,903, issued to Joseph R. Alloway on Jan. 5, 1982; U.S. Pat. No. 4,327,787, issued to Robert J. Loratto on May 4, 1982; U.S. Pat. No. 4,350,192, issued to Thomas Dent on Sep. 21, 1982; U.S. Pat. No. 4,379,475, issued to Ronald W. Nokes on Apr. 12, 1983; U.S. Pat. No. 4,405,005, issued to Dieter S. Zanker on Sep. 20, 1983; U.S. Pat. No. 4,431,040, issued to Kenneth L. Friedrich et al on Feb. 14, 1984; U.S. Pat. No. 4,577,667, issued to Kevin Gray et al on Mar. 25, 1986 and U.S. Pat. No. 5,495,878, issued to Robert E. McKenen, Jr., on Mar. 5, 1996.

As also stated in the Lamoureux and MacPhee patent, most of the patented devices are not multi-purpose, some of the tools are unsafe, and the load bearing surface of others are quite small. The Lamoureux and MacPhee tool provided solutions to the problems inherent to existing devices. Likewise, the tool of the present invention offers solutions to such problems, and also improves upon the Lamoureux and MacPhee device.

### SUMMARY OF THE INVENTION

The present invention provides a multi-purpose impact tool comprising:

an elongated guide bar including cylindrical top and bottom ends, an intermediate section having a polygonal cross section;

an annular guide disc on the cylindrical top end of said guide bar;

a head for mounting on the cylindrical bottom end of said guide bar, said head having an impact surface at a bottom end thereof for delivering an impact force from the tool;

a cylindrical steel sleeve for sliding on said guide disc, said sleeve having an open top end and a bottom end defining a contact surface, whereby, when the sleeve is reciprocated on said guide bar, said contact surface reciprocates against said head to deliver said impact force;

a plug in the bottom end of said sleeve;

a polygonal hole in said plug for receiving said guide bar whereby the sleeve cannot rotate relative to the guide bar when the sleeved is reciprocated on the guide bar; and

a lock on an upper end of said sleeve for locking the guide bar in the sleeve when the impact device is not in use.

One important feature of the present invention is a much improved mechanism for locking the tool in a non-use condition, in which a sleeve slidable on a guide bar is locked in a fixed position.

Another improvement over the existing tool is the use of polyurethane rather than metal in an element of the invention where it is not required. By reducing weight in this manner, weight is concentrated in the force impacting element of the tool.

Another novel feature is the use of a square section guide bar and a square hole in a plug at the bottom of the sleeve. These elements allow the user to keep the tool at a fixed angle to the vertical as opposed to a round guide bar which cannot be held at an angle.

Another improvement is the possibility of adding two weights which increases the flexibility of the device; lighter for ease of use, heavier for more force.

The addition of a synthetic washer on the striking surface reduces the sound and reduces the creation of harmful harmonic waves.

### BRIEF DESCRIPTION OF THE DRAWINGS

The invention is described below with reference to the accompanying drawings, which illustrate preferred embodiments of the invention, and wherein:

FIG. 1 is an isometric view of an impact tool in accordance with the invention;

FIG. 2 is an exploded, isometric view of the tool of FIG. 1;

FIG. 3 is an isometric view of a second embodiment of the impact tool;

FIG. 4 is an exploded, isometric view of the tool of FIG. 3;

FIG. 5 is a partly sectioned isometric view of a guide bar used in the tool of FIG. 4; and

FIG. 6 is an exploded, isometric view of a lock mechanism used in the tool of FIGS. 3 and 4.

### DETAILED DESCRIPTION OF THE INVENTION

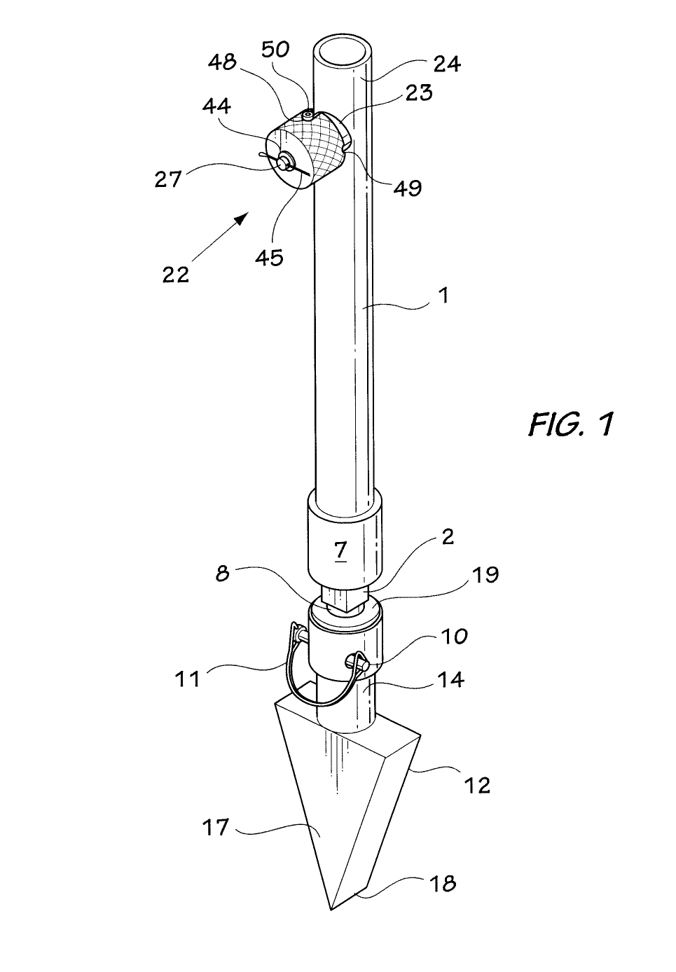

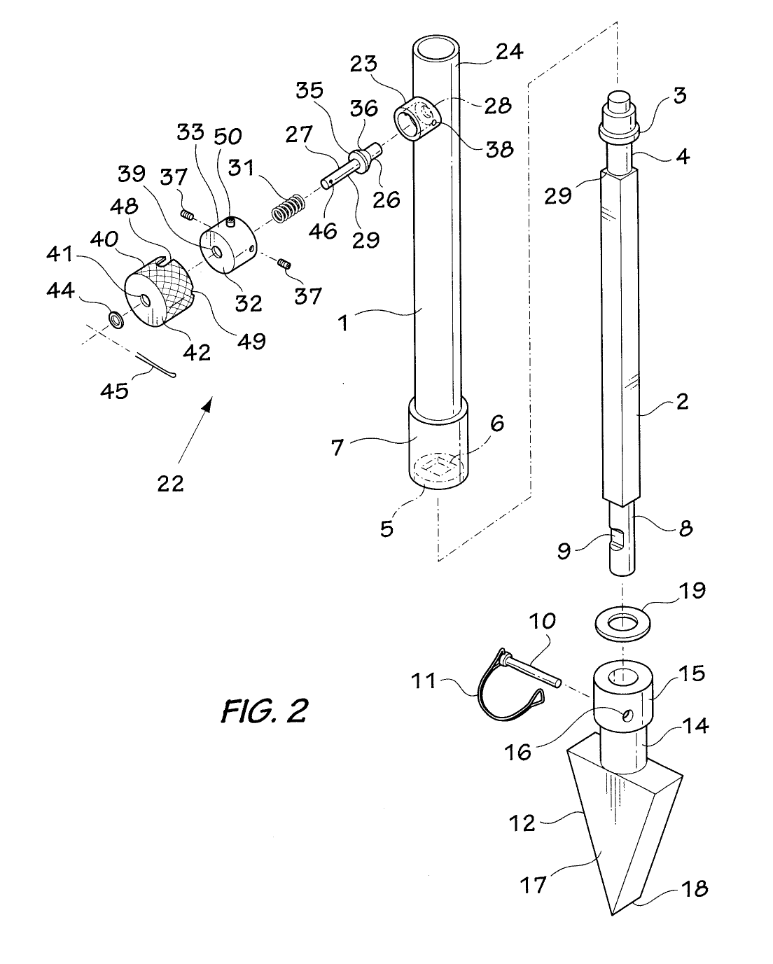

Referring to FIGS. 1 and 2, one embodiment of the improved impact tool includes an elongated, tubular power bar or sleeve 1, slidable on a steel guide bar 2. The guide bar 2 is defined by a square cross section body. The length of a diagonal between the corners of the body is slightly less than the diameter of the sleeve 1. In order to reduce friction, a disc 3 is mounted on the cylindrical top end 4 of the bar 2. The disc 3 has a diameter only slightly smaller than the interior diameter of the sleeve 1, and consequently is only one of two parts of the bar which contact the sleeve 1. A disc-shaped plug 5 with a square hole 6 therein is mounted in the bottom end 7 of the sleeve 1. During movement of the sleeve 1 on the bar 2, the sleeve and the plug 6 slide on the square cross section portion of the bar. Because the hole 6 in the plug 5 and a major portion of the bar 2 are square, the sleeve cannot rotate relative to the bar.

While the dimensions of the elements of the tool are not critical, in one preferred embodiment, the sleeve 1 has a length of 42″, an outside diameter of 1½ ″ and an interior diameter of 1″, the bar 2 has a length of 43″ and a diagonal dimension of slightly less than 1″, and the disc 3 has a diameter of 15/16″. As a result, the sleeve 1 slides smoothly and easily on the guide bar 2.

The cylindrical bottom end 8 of the guide bar 2 includes a notch 9 (FIG. 2) for receiving the rod 10 of a three-point pin 11, which is used to connect a variety of heads 12 (one shown) to the bar 2. The heads can be used for a variety of purposes including those described in the Lamoureux and MacPhee U.S. Pat. No. 6,109,365. The head 12 shown in FIGS. 1 and 2 is designed for splitting wood, and includes a solid, cylindrical neck 14 with a tubular socket 15 on the top end thereof for receiving the bottom end 8 of the guide bar 2. Aligned holes 16 (one shown) in the socket 15 receive the rod 10 of the three-point pin 11. The rod 10 extends through the holes 16 and the notch 9 to releasably connect the head 12 to the bar 2. The lower end 17 of the head 12 is wedge-shaped with a pointed bottom tip 18.

A plastic washer 19 is loosely mounted on the top end of the head 12 and extends around the cylindrical bottom end 8 of the guide bar 2. During use, the washer 19 prevents metal against metal contact between the large diameter bottom end 7 of the sleeve 1 and the top end of the head 12. Moreover, the washer 19 reduces noise and the creation of harmful harmonic waves. When the tip 18 of the head 12 is placed against a piece of wood (not shown) to be split, and the sleeve 1 is manually slid upwardly and then rapidly downwardly relative to the bar 2, the bottom end of the sleeve 1 strikes the washer 19, and the force of impact is transmitted to the head 12 to drive the head into the wood.

When not in use, the bar 2 is locked in the sleeve 1; otherwise, the bar could slide out of the sleeve when the tool is lifted, possibly causing injury. The sleeve 1 is locked on the bar 2 in the non-use position using a lock indicated generally at 22. As best shown in FIG. 2, the lock 22 includes a tubular barrel 23 extending outwardly from one side of the top end 24 of the sleeve 1 at 90° thereto. The inner end 26 of a bolt 27 is slidable in a countersunk hole 28 (FIG. 2) in the sleeve 1 for entering the space between the ring 3 and the top end 29 of the square section of the bar 2. The bolt 27 is biased into the locked position by a helical spring 31 mounted on the outer end 29 of the bolt 27. The spring 31 is located between the outer end 32 of an inner cap 33 and an annular flange 35 on the bolt 27. The inner end 36 of the flange 35 is tapered for mating with the hole 28 in the sleeve 1. The inner cap 33 is mounted in a fixed position on the barrel 23 using screws 37 which extend through the inner cap into threaded holes 38 in the barrel. The outer end 29 of the bolt 27 extends outwardly through a hole 39 in the closed outer end 32 of the tubular inner cap 33. An outer cap 40 is slid onto the inner cap 33 so that the bolt 27 extends outwardly through a hole 41 in the otherwise closed outer end 42 of the cap 40. A washer 44 is placed on the outer end of the bolt and a cotter pin 45 is inserted through a diametrically extending hole 46 in the outer end of the bolt to tie the lock together.

A pair of spaced apart notches 48 and 49 are provided in the open inner end of the outer cap 40 for receiving a screw 50 mounted in the inner cap 33 proximate the inner end thereof. As best shown in FIG. 2, the notch 48 is deeper than the notch 49. In the locked condition of the tool (FIG. 1), the screw 50 is located in the deeper notch 48, i.e. the notch 48 is aligned with the screw 50 and the cap 40 is pushed inwardly, sliding the bolt into the gap 4 between the ring 3 and the top end of the square cross section portion of the bar 2. In such use condition, the spring 31 is extended, i.e. relaxed on the bolt 27 between the outer end 32 of the inner cap 33 and the flange 35 on the bolt 27. In this connection, it will be appreciated that the shaft 27 and the cap 40 move as one unit relative to the fixed inner cap 33. When the outer cap 40 is pulled away from the stationery inner cap 33 the bolt slides outwardly releasing the sleeve 1 from the bar 1, and the spring 31 is compressed between the end 32 of the inner cap 33 and the bolt flange 35. By rotating the cap 40, the notch 49 is aligned with the screw 50. When released the cap 40 moves slightly inwardly. Because the notch 49 is not as deep as the notch 48, the spring remains compressed and the bolt 27 remains in the outer position with the sleeve 1 released from the bar 2. To again lock the sleeve 1 to the bar 2, the outer cap 40 is pulled slightly outwardly on the inner cap 33, and the cap 40 is rotated to the position shown in FIG. 1 and released. The spring 31 pushes the bolt 27 inwardly to the locked position.

In the following description of page 3 to 6 of the drawings, wherever possible the same reference numerals have been used to identify elements similar to the elements of the tool illustrated in FIGS. 1 and 2.

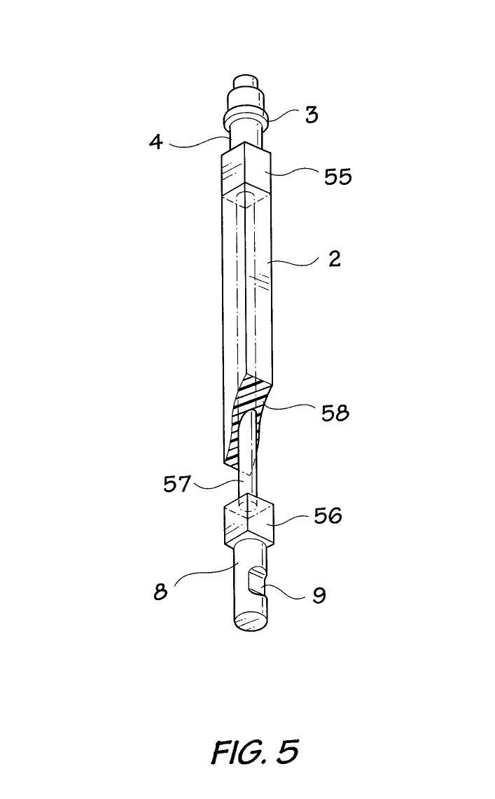

The second embodiment of the tool is essentially the same as the apparatus of FIGS. 1 and 2. As best shown in FIG. 5, the square cross section portion of the guide bar 2 is defined by a mild steel bar having square cross section, upper and lower ends 55 and 56, respectively, interconnected by a reduced diameter intermediate section 57. The intermediate area 57 of the bar 2 is coated with polyurethane bonded to the steel. An example of the polyurethane used on the intermediate section 57 is Adiprene® LS 700D, which is bonded to the steel using Chemlok®213. The resulting bar 2 is substantially lighter than the solid steel bar 2 used in the first embodiment of the tool.

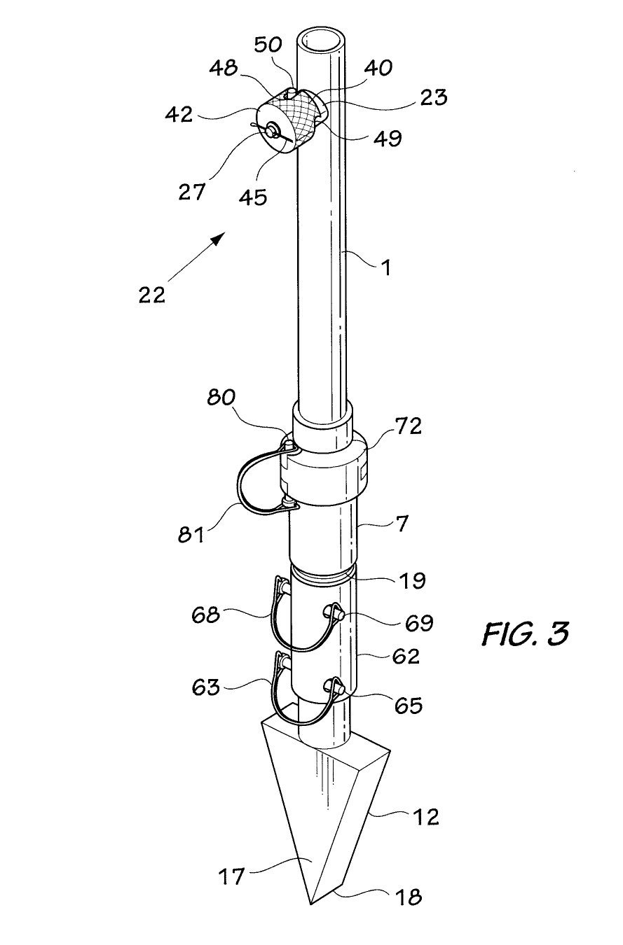

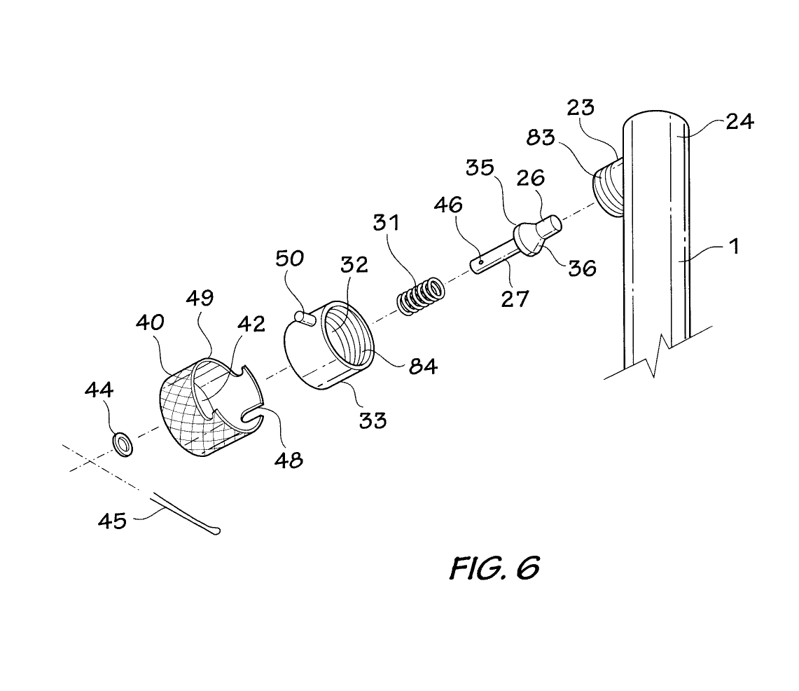

The head 12 of the tool of FIGS. 3 to 6 includes a cylindrical post 60 on the top end thereof, with a reduced diameter upper end 61 for mating with a tubular weight 62. The weight 62 is connected to a head 12 via a three-point pin 63, the rod 65 of which extends through aligned holes 66 (one shown) in the sleeve 62 and a notch 67 in the upper end 61 of the head 12. The top end of the tubular weight 62 receives the bottom end 8 of the bar 2, and is connected thereto by a three-point pin 68, the rod of which extends through aligned holes 70 in the weight 62 and the notch 9 in the guide bar 2.

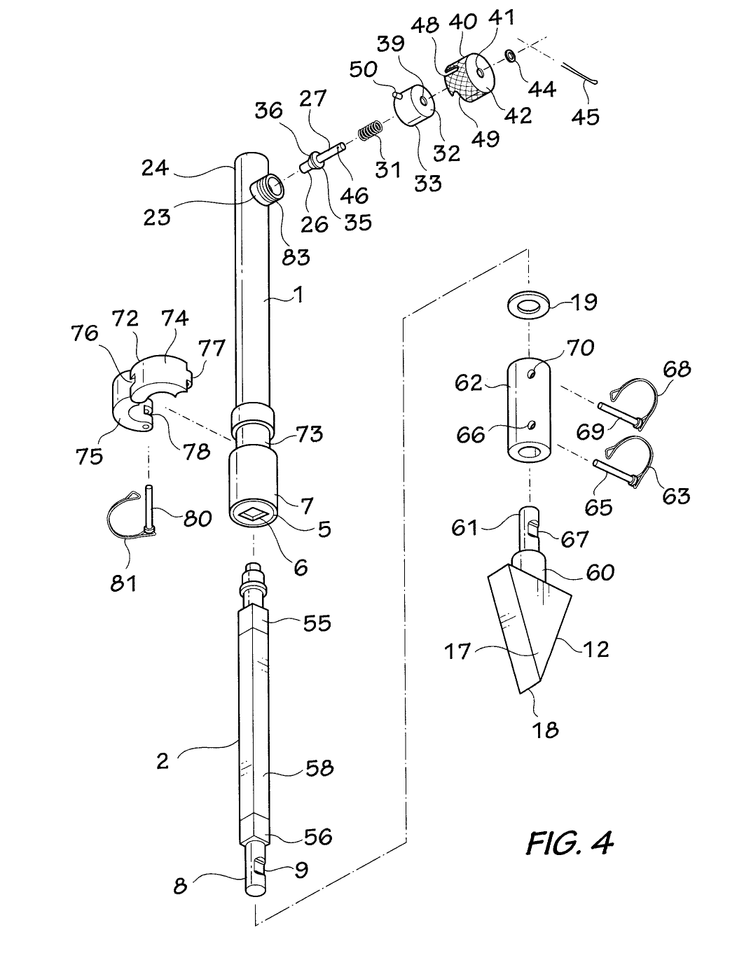

An additional feature of the tool of FIGS. 3 and 4 is a weight 72 attached to the sleeve 1 near its bottom end 7. For such purpose, an annular groove 73 is provided near the bottom end 7 of the sleeve 1 for receiving the weight 72. The sleeve 72 is defined by two semi-circular sections 74 and 75 interconnected by a hinge 76. An ear 77 on the free end of the section 74 mates with a notch 78 in the free end of the section 75 and the rod 80 of a three-point pin 81 is inserted through aligned holes in the ends of the sections 74 and 75 to latch them together. Of course, two or more weights can be attached to the sleeve 1 improving the versatility of the tool. A light device is easier to use, and a heavy device provides a greater force.

Finally, in the lock 22 of FIGS. 3 and 4, the barrel 23 includes external threads 83 and the inner sleeve 33 contains inner threads 84. Thus, the inner cap 33 is merely threaded onto the barrel 23.

1. A multi-purpose impact tool comprising:
an elongated guide bar including cylindrical top and bottom ends, an intermediate section having a polygonal cross section;
an annular guide disc on the cylindrical top end of said guide bar;
a head for mounting on the cylindrical bottom end of said guide bar, said head having an impact surface at a bottom end thereof for delivering an impact force from the tool;
a cylindrical steel sleeve for sliding on said guide disc, said sleeve having an open top end and a bottom end defining a contact surface, whereby, when the sleeve is reciprocated on said guide bar, said contact surface reciprocates against said head to deliver said impact force;
a plug in the bottom end of said sleeve;
a polygonal hole in said plug for receiving said guide bar whereby the sleeve cannot rotate relative to the guide bar when the sleeved is reciprocated on the guide bar; and
a lock on an upper end of said sleeve for locking the guide bar in the sleeve when the impact device is not in use.

2. The impact tool of claim 1, wherein said intermediate section of said guide bar includes upper and lower shoulders, a reduced diameter rod integral with and extending between said shoulders, and a plastic coating bonded to the rod whereby the combined rod and coating has the same cross-sectional dimensions as the shoulders.

3. The impact tool of claim 2, wherein said head includes a solid cylindrical neck, a socket in said neck for receiving the cylindrical bottom end of said guide bar, and aligned holes in the socket for receiving a rod of a three-point pin; and said cylindrical bottom end of the guide bar includes a notch for also receiving the rod of the three-point pin to secure the head on the bottom end of the guide bar.

4. The impact tools of claim 3, wherein said lock includes a tubular barrel extending outwardly from the upper end of the sleeve, a hole in the sleeve aligned with a longitudinal axis of the barrel, and a retractable bolt slidable in the hole for entering a space between the guide disc and a top end of the intermediate section of the guide bar to lock the guide bar in the sleeve.

5. The impact tool of claim 4, wherein said lock includes a helical spring on the bolt for biasing the bolt into a locked position, an inner cap fixed on said barrel and containing said spring and an inner end of said bolt; a first hole in an outer end of said inner cap, an outer cap slidable and rotatable on said inner cap, a second hole in an outer end of said outer cap aligned with said first hole for receiving an outer end of said bolt, and a pin extending diametrically through the outer end of the bolt, whereby, when the outer cap is pulled away from the fixed inner cap, the bold slides outwardly to release the sleeve from the guide bar and the spring is compressed, and rotation of the outer cap locks the bolt in the retracted position.
